(19) United States
(12) Patent Application Publication
(10) Pub. No.: US 2007/0168252 A1
(43) Pub. Date: Jul. 19, 2007

(54) Method and system for dynamically prioritizing advertiser communications over a network based on telephone numbers

(76) Inventor: Travis W. Tisa, Webster, NY (US)

Correspondence Address: LATHROP & GAGE LC, 2345 GRAND AVENUE, SUITE 2800, KANSAS CITY, MO, 64108, US

(21) Appl. No.: 11/504,556

(22) Filed: Aug. 15, 2006

Related U.S. Application Data
(60) Provisional application No. 60/759,824, filed on Jan. 18, 2006.

(51) Int. Cl. G06Q 30/00

(52) U.S. Cl. 705/14

(57) ABSTRACT

A communication routing system utilizes an online network-based auction marketplace, typically in real time. The system routs received telephonic communications to specific intended destinations in accordance with modifiable bid amounts entered by entities associated with the specific intended destinations.

### CROSS-REFERENCES TO RELATED APPLICATIONS

This application is related to and claims priority from U.S. Provisional Patent Application Ser. No. 60/759,824, filed, Jan. 18, 2006, entitled: METHOD AND SYSTEM FOR DYNAMICALLY PRIORITIZING ADVERTISER COMMUNICATIONS OVER A NETWORK BASED ON TELEPHONE NUMBERS, the disclosure of which is incorporated by reference in its entirety herein.

### TECHNICAL FIELD

There is disclosed a communication routing system that utilizes an online network-based auction marketplace. The system receives a communication, typically originating telephonically by an audio (voice) call, and routs the communication to a destination, typically by an audio (voice) call, corresponding to the entity whose bid was the highest to receive the aforementioned communication.

### BACKGROUND

Advertising over networks, such as the Internet, takes various forms. For example, an advertiser may own or secure access to a Website and post advertising on this Website. A consumer accesses this Website by obtaining the Website address, through general knowledge or a search engine, and either manually enters its address into his or her Web browser, or clicks on a link that will direct his or her Web browser to the Website. The consumer may also enter words or groups of words into a search engine. The entered words may be keywords that are assigned to data objects for the desired products, services or other items of information. The user then receives listings for Websites or pages with links, that when clicked, will direct the user's Web browser to the corresponding Website. Alternatively, an advertiser will actively seek customers, who will respond to the advertiser by directing their Web browsers to the advertiser's Website. For example, an advertiser may send an electronic communication, such as an electronic mail (e-mail), to a potential customer. Once the e-mail is opened, it includes a link, that when clicked, directs the user's browser to a particular Website.

These electronic methods of advertising each share the same type of advantage in common, when compared to a print publication with equivalent distribution. This advantage is the ability to continually deliver the most profitable (or otherwise most qualified) advertiser, in real-time, based on an online auction marketplace, among other things. In contrast, a printed advertisement distributed by postal delivery or retail store distribution after publication in a magazine or newspaper is sold by a salesperson for a fixed price, days or months before the advertisement is displayed.

For example, it is common for advertisers to bid for placement of their advertisements on the Internet in an auction style electronic marketplace, based on product category, over search (that is, entering a keyword into a search box), banner, email or other electronic channels. Generally, the most profitable marketer's advertisement is displayed most prominently (for example, first in a list of similar competing marketers) to a consumer. Thus, for example, advertisements may change each time a consumer visits the same Web site. Advertisers cannot bid in the same way for publication of advertisements in a printed publication.

The traditional manner in which an advertiser places its advertisement in a printed publication is to be the first to call and request a particular space in the publication, prior to the applicable deadline, and offer the price demanded by the publisher. Nationally published magazines are generally distributed weekly or monthly; newspapers are often distributed daily or weekly. Consumers may benefit more from electronic advertising than printed advertising with regard to being informed of a more current, varied and relatively accurate set of offers.

However, printed advertisements have their own set of advantages over electronic advertisements. A consumer may not have access to a computer or other device able to display an electronic advertisement for any number of reasons, including the cost of owning such a device. Other examples why a consumer may not have access to a device at a given time include: the relative cost of such a device compared to a newspaper may restrict where a consumer wishes to bring or carry the device (for example, weather conditions or space constraints) at a particular time; the size of the device may make it impractical to carry from one location to another; the relative complexity of the device compared to reading a newspaper or magazine may make it impractical to use the device at various times (such as during a lunch break).

### SUMMARY

The disclosed subject matter captures the advantages of both electronic advertising and printed advertising, combining them in a manner which provides a higher payout to the content publisher (i.e., the newspaper, Website, etc.), when compared to electronic advertising and print advertising on their own. There is disclosed a communication routing system that utilizes an online network-based auction marketplace, typically in real time. The system routs received telephonic communications to specific intended destinations in accordance with modifiable bid amounts entered by entities, for example, advertisers, web site promoters, or other information or content providers, associated with the specific intended destinations (for example, addresses, such as telephone numbers).

Throughout this document, textual and graphical references are made to actual and fictional trademarks and Internet addresses (Uniform Resource Locators, also known as URLs). Also, throughout this document, numerous textual and graphical references are made to actual and fictional trademarks. The aforementioned trademarks and Internet addresses are for explanation purposes only, and any association with any party or other entity is coincidental, unintentional and unrelated thereto. All trademarks are the property of their respective owners, and are referenced only for explanation purposes herein.

An embodiment of the disclosed subject matter is directed to a method for providing a communication to a recipient. The method includes, maintaining a database including, a plurality of addresses, each address associated with each recipient who has entered a modifiable bid amount for at least one category, and, at least one modifiable bid amount corresponding to the at least one category. A communication, for example, in the form of telephonic data, associated with an audio or voice call, is received from a user. The communication is associated with the at least one category; and, the communication is assigned to the address associated with at least one recipient who has entered a modifiable bid amount. The communication is ultimately routed, as telephonic data, to a destination address associated with the at least one recipient.

Another embodiment of the disclosed subject matter is directed to a system for providing a communication to a recipient. The system includes at least one database including, a plurality of addresses, each address associated with each recipient who has entered a modifiable bid amount for at least one category, and, at least one modifiable bid amount corresponding to the at least one category. There is a first component for receiving a communication from a user, a second component for associating the communication with the at least one category, and, a third component for assigning the communication to the address associated with at least one recipient who has entered a modifiable bid amount.

Another embodiment is directed to a computer-usable storage medium. The storage medium has a computer program embodied thereon, for causing a suitably programmed system to provide a communication to a recipient, by performing the following steps, when such program is executed on the system. The steps include maintaining a database including, a plurality of addresses, each address associated with each recipient who has entered a modifiable bid amount for at least one category, and, at least one modifiable bid amount corresponding to the at least one category. The steps also include, receiving a communication from a user, associating the communication with the at least one category, and, assigning the communication to the address associated with at least one recipient who has entered a modifiable bid amount.

Another embodiment is directed to a method for providing a communication to a recipient. The method includes maintaining a database including, a plurality of addresses, each address associated with each recipient of a plurality of recipients who have entered a modifiable bid amount for at least one category, and, the modifiable bid amounts corresponding to the at least one category. The method also includes, receiving a communication from a user and ordering the modifiable bid amounts for the at least one category in accordance with at least one first predetermined criteria, for example, monetary amounts of each modifiable bid amount. The communication is associated with the at least one category; and, the communication is assigned to the address associated with at least one recipient whose modifiable bid amount for the at least one category is selected in accordance with at least one second predetermined criteria, for example, the highest monetary amount for the bid amount, or one of a rule and/or a policy. The method also includes deducting an amount of money corresponding to the modifiable bid amount, from an account associated with the at least one recipient, once the communication assigned to the address of the at least one recipient has reached the destination corresponding to the address associated with the at least one recipient.

Another embodiment is directed to a system for providing a communication to a recipient. The system includes, at least one database including, a plurality of addresses, each address associated with each recipient of a plurality of recipients who have entered a modifiable bid amount for at least one category, and, the modifiable bid amounts corresponding to the at least one category. There is also a first component for receiving a communication from a user, and, a bidding engine. The bidding engine performs functions such as, ordering the modifiable bid amounts for the at least one category in accordance with at least one first predetermined criteria, for example, monetary amounts of each modifiable bid amount, associating the communication with the at least one category, and, assigning the communication to the address associated with at least one recipient whose modifiable bid amount for the at least one category is selected in accordance with at least one second predetermined criteria, for example, the highest monetary amount, a rule and/or a policy. The system also includes a component for deducting an amount of money corresponding to the modifiable bid amount, from an account associated with the at least one recipient, whose modifiable bid amount for the at least one category was selected in accordance with at least one second predetermined criteria.

Another embodiment is directed to a computer-usable storage medium. The storage medium has a computer program embodied thereon, for causing a suitably programmed system to provide a communication to a recipient, by performing the following steps, when such program is executed on the system. The steps include, maintaining a database including, a plurality of addresses, each address associated with each recipient of a plurality of recipients who have entered a modifiable bid amount for at least one category, and, the modifiable bid amounts corresponding to the at least one category. The steps also include receiving a communication from a user, ordering the modifiable bid amounts for the at least one category in accordance with at least one first predetermined criteria, associating the communication with the at least one category; and,

assigning the communication to the address associated with at least one recipient whose modifiable bid amount for the at least one category is selected in accordance with at least one second predetermined criteria. The steps further include deducting an amount of money corresponding to the modifiable bid amount, from an account associated with the at least one recipient, once the communication assigned to the address of the at least one recipient has reached the destination corresponding to the address associated with the at least one recipient.

Another embodiment is directed to a method for providing a communication to a recipient. The method includes maintaining a database including, a plurality of addresses, each address associated with each recipient of a plurality of recipients who have entered a modifiable bid amount for at least one category, and, the modifiable bid amounts corresponding to the at least one category. A communication is received from a user, and the modifiable bid amounts, from the recipients, are ordered for the at least one category in accordance with their (monetary) amounts. The communication is associated with the at least one category, and it is assigned to the address associated with the recipient whose modifiable bid amount for the at least one category is the highest ordered bid.

Another embodiment is directed to a method for providing a communication to a recipient. The method includes receiving modifiable bid amounts from recipients, each modifiable bid amount associated with at least one category and an address corresponding to the recipient associated with the respective modifiable bid amount. A communication is then received from a user, and the modifiable bid amounts for the at least one category are ordered in accordance with at least one first predetermined criteria. The communication is associated with the at least one category, and a modifiable bid amount is selected based on at least one second predetermined criteria. The communication is assigned to the address associated with the recipient whose modifiable bid amount for the at least one category was selected. An amount of money corresponding to the modifiable bid amount, from an account associated with the recipient, whose modifiable bid was selected, is deducted (debited) from the requisite account, once the communication assigned to the address of the recipient has reached the destination corresponding to the address associated with the recipient.

Yet another embodiment is directed to a system for providing a communication to a recipient. The system includes a first component for receiving modifiable bid amounts from recipients, each modifiable bid amount associated with at least one category and an address corresponding to the recipient associated with the respective modifiable bid amount. There is a second component for receiving a communication from a user, and a bidding engine. The bidding engine is operational for ordering the modifiable bid amounts for the at least one category in accordance with at least one first predetermined criteria, associating the communication with the at least one category, selecting the modifiable bid amount based on at least one second predetermined criteria, and, assigning the communication to the address associated with the recipient whose modifiable bid amount for the at least one category was selected.

Another embodiment is directed to a computer-usable storage medium. The storage medium has a computer program embodied thereon, for causing a suitably programmed system to provide a communication to a recipient, by performing the following steps, when such program is executed on the system. The steps include, receiving modifiable bid amounts from recipients, each modifiable bid amount associated with at least one category and an address corresponding to the recipient associated with the respective modifiable bid amount; receiving a communication from a user; ordering the modifiable bid amounts for the at least one category in accordance with at least one first predetermined criteria; associating the communication with the at least one category; selecting the modifiable bid amount based on at least one second predetermined criteria; and, assigning the communication to the address associated with the recipient whose modifiable bid amount for the at least one category was selected.

### BRIEF DESCRIPTION OF THE DRAWINGS

Attention is now directed to the drawings, where corresponding or like numerals or characters indicate corresponding or like components. In the drawings:

FIG. 1 is a diagram of the disclosed system in an exemplary operation;

FIG. 2A is a diagram of the architecture for the system of FIG. 1;

FIG. 2B is a diagram of a sub database for an account of FIG. 2A;

FIGS. 3A and 3B form a flow diagram of a method performed by the system and components associated therewith;

FIGS. 4A-4L are screen displays of the different aspects for data entry and account administration for the system; and,

FIG. 5 shows an exemplary operation of the system.

### DETAILED DESCRIPTION

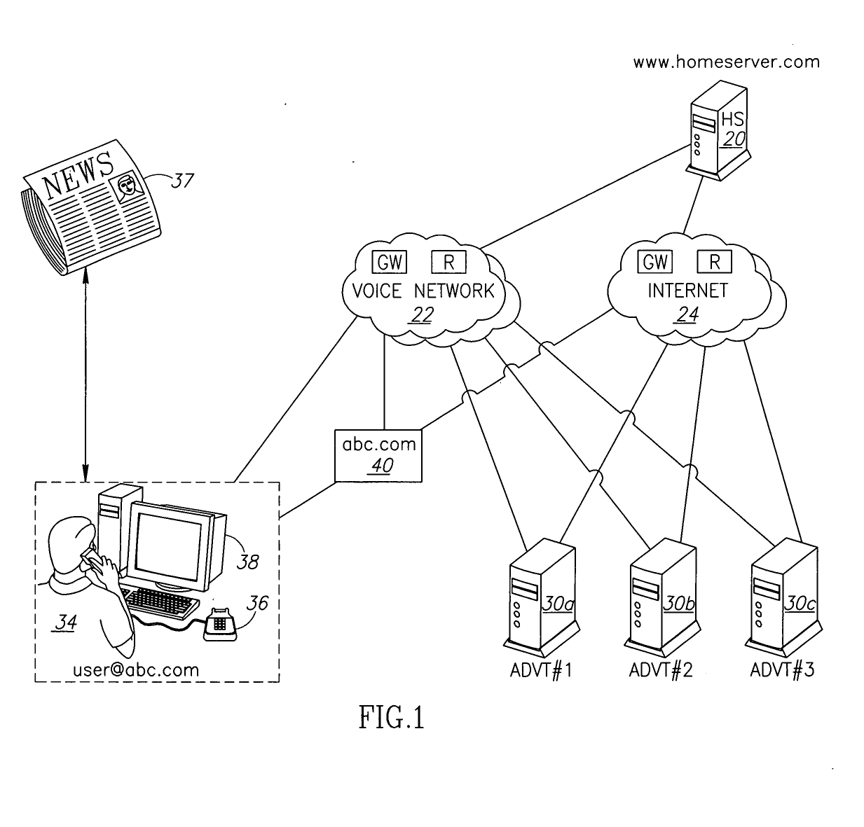

FIG. 1 shows a system in an exemplary operation for performing the operations disclosed herein. The system is typically centered around a home server (HS) 20, that is linked electronically to networks, such as a voice network 22 and a wide area network (WAN), such as public network, typically, the Internet 24. Other servers, for example, servers 30a, 30b, 30c (representative of advertisers, for example, indicated as ADVT #1, ADVT #2, ADVT #3) are also linked to the Internet 24, and typically, also to the voice network 22. Throughout this document, reference to a “server” includes a remote computer or remote computer system, or computer program therein, that is accessible over a communications medium, such as the voice network 22 or the Internet 24, that provides services to other computer programs (and their users), in the same or other computers.

The voice network 22 and the Internet 24 typically include one or more gateways (GW) and routers (R) (represented by the elements labeled “GW” for gateway and “R” for router) and to support voice over Internet protocol (VoIP) communications, for example, telephonic (telephone) communications such as audio or voice calls, that are typically packetized, between all components in or along the voice network 22 or the Internet 24 (with the Internet 24 typically supporting data (includes packetized communications between the aforementioned components).

Users, for example, represented by the user 34, through his telephone 36 (for example, dialing a telephone number from a publication, such as a newspaper 37) or computer 38 may be linked to one or both of the voice network 22 or the Internet 24. For purposes of explanation, the user has the electronic mail (e-mail) address of user@abc.com.

All of the aforementioned servers 20, 30a-30c, are typically linked (either directly or indirectly) to the voice network 22 and/or the internet 24, so as to be in communication with each other. An endless number of servers, including domain servers 40 for the domains (for example, the domain “abc.com”) associated with the computer 38 user of the 34 (representative of multitudes of users), may also be linked to the voice network 22 and/or Internet 24. Additionally, all of the aforementioned servers include components for accommodating various server functions, in hardware, software, or combinations thereof, and typically include storage media, either therein or associated therewith. Also in this document, the aforementioned servers, storage media and components, can be linked to each other, to the voice network 22 and/or the Internet 24, either directly or indirectly.

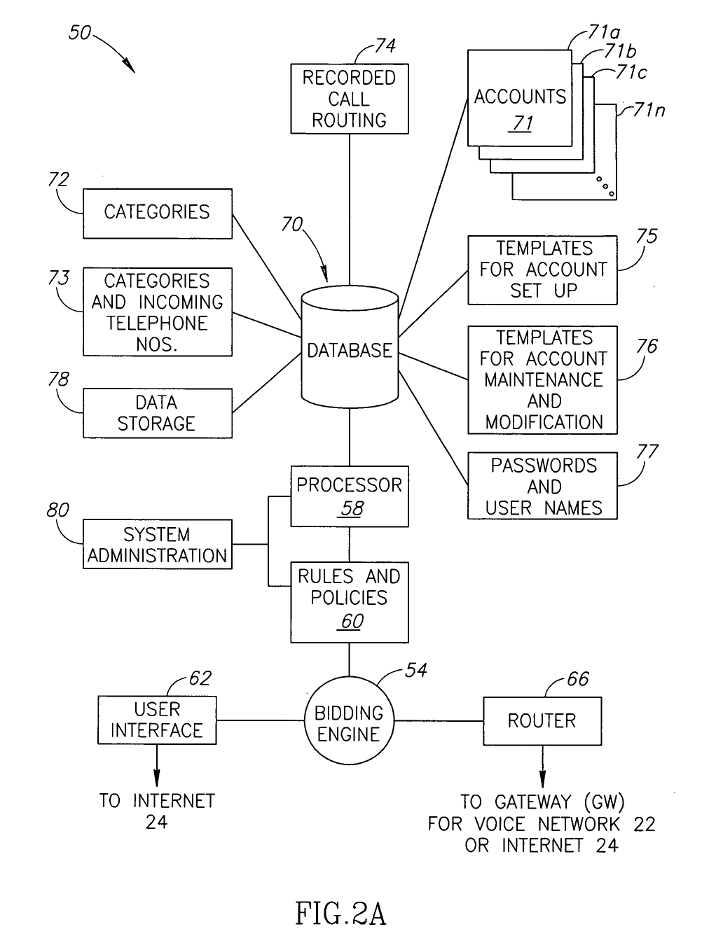

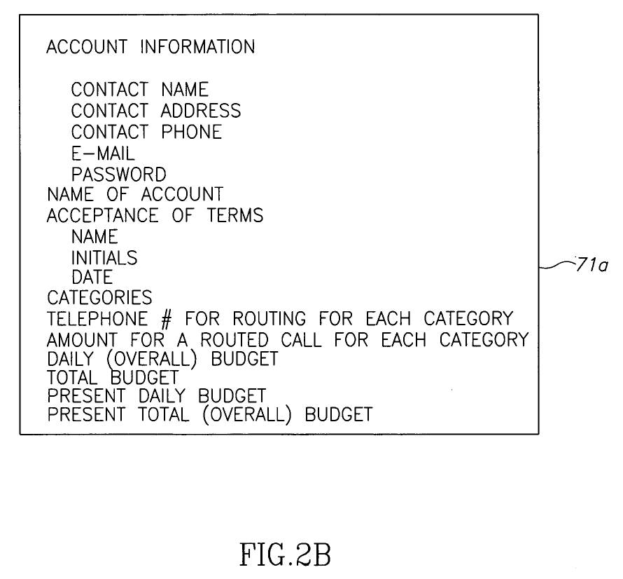

The home server (HS) 20, as shown in FIG. 2A, is of an architecture that includes a system 50 of components for performing various methods and processes. For explanation purposes, the home server (HS) 20 may have a uniform resource locator (URL) of www.homeserver.com. While the system 50 includes numerous components, these components are selected and arranged in an exemplary manner and other components and arrangements are also permissible, provided they perform the below mentioned functions.

The home server (HS) 20, through the system 50 of its architecture, performs numerous functions, for example, accounting functions, such as debiting accounts of advertisers represented by servers 30a-30c corresponding to (advertiser (Advt) #1 to Advertiser (Advt) #3, respectively), when an audio or voice call has successfully reached its destination, as well as crediting these accounts with funds when entered into the system. For example, funds may come into the system 50 from credit cards (detailed below), bank transfers, checks, money orders, and the like. While accounts are typically credited and debited automatically, by software hardware, or combinations thereof, the crediting and/or debiting processes as well as suspension and activation of accounts may be performed manually by the system administrator, represented, for example, by the module 80, or the like.

The architecture of the home server (HS) 20 includes components for providing numerous additional functionalities. In particular, there is a bidding engine, 54, that accepts, arranges and organizes bids (that are modifiable) for the requisite categories, in an auction-like manner, typically in real time. The categories are held in a category database 72. The requisite categories include words, group of words, phrases, or words or word groups commonly known as “keywords.”

The bidding engine 54 is, for example, is referred to as an “engine” as it is an algorithm or program which performs a core or essential function for other programs, and can be a central or focal program in an operating system, subsystem, or application program that coordinates the overall operation of other programs. For each category, based on the requisite audio or voice call being handled, the bidding engine 54, will assign a destination address, for example, a telephone number, to the instant audio (voice) call, corresponding to the advertiser, whose bid has been selected by the bidding engine 54 (typically subject to rules and/or policies, stored in the rules and policies processor 60).

The home server (HS) 20, and the system 50, typically include components, for example, for performing comparison and matching functions, policy and/or rules processing, and various operational engines. The home server (HS) 20 (and the system 50) includes various processors 58 including microprocessors for performing all of the functionalities and applications listed herein for the home server (HS) 20. There is also a rules and/or rules and policies processor 60 associated with the bidding engine 54 that may be used in determining the bid to be selected, in accordance to any of the rules and or policies for selecting the requisite bid.

A user interface 62, allowing advertising users to interact with the system 50, typically over a network such as the Internet, is typically coupled with the bidding engine 54. A graphical user interface (GUI) for the advertising users, for example, as represented by servers 30a-30c, corresponds to Advertiser #1 (Advt #1) to Advertiser #3 (Advt #3) respectively, through which data is received and inputted into the system 50, is typically associated with the user interface 62.

The bidding engine 54 is also coupled to a router 66, that will rout the communication, typically the audio or voice call (as packetized data) to its destination (destination address), in accordance with the selected bid. The router 66 may be external to the home server (HS) 20 if desired.

The home server (HS) 20 also includes a database or data store 70. The database or data store 70, shown as a single unit, may be multiple units. The database or data store 70 is formed from sub-databases or sub-data stores 71-78, for example, for accounts 71, categories (the various categories open for bidding) 72, categories mapped to corresponding addresses such as incoming telephone numbers 73, data for recording voice call routing and arrival at the intended destination 74, templates for account set up 75, templates for account maintenance 76, passwords and user names 77, and additional data storage 78 (and other functions).

The accounts sub database 71 is made up of files 71a-71n (“n” representing the last in an indeterminate sequence or series), representing each account for the multitudes of advertisers or advertising users (Advt #1 to Advt #3) (for example, represented by servers 30a-30c). As shown in FIG. 2B, file 71a, is representative of all files 71a-71n for advertiser accounts and includes various fields. These fields include, for example, Account Information, including, contact name of the advertiser, the contact address, the contact telephone number, the contact e-mail, the user's e-mail (user name), and the password. The advertiser may enter a name of their reference or campaign (typically for their internal reference). There is also a field for acceptance of terms, the name of the person who accepted the terms for using the system, and that persons initials (serving as his signature), and the date of the initialing (typically automatically entered). There is also one or more fields for categories, each category selected, including a destination address, for example, a telephone number for the category to which a routed communication, typically an audio or voice call will be directed (should the advertiser's bid for the category be selected by the bidding engine 54), and a bid amount. There are also fields for daily budget and a total or budget for this advertiser, as well as the present amounts for these two budgets.

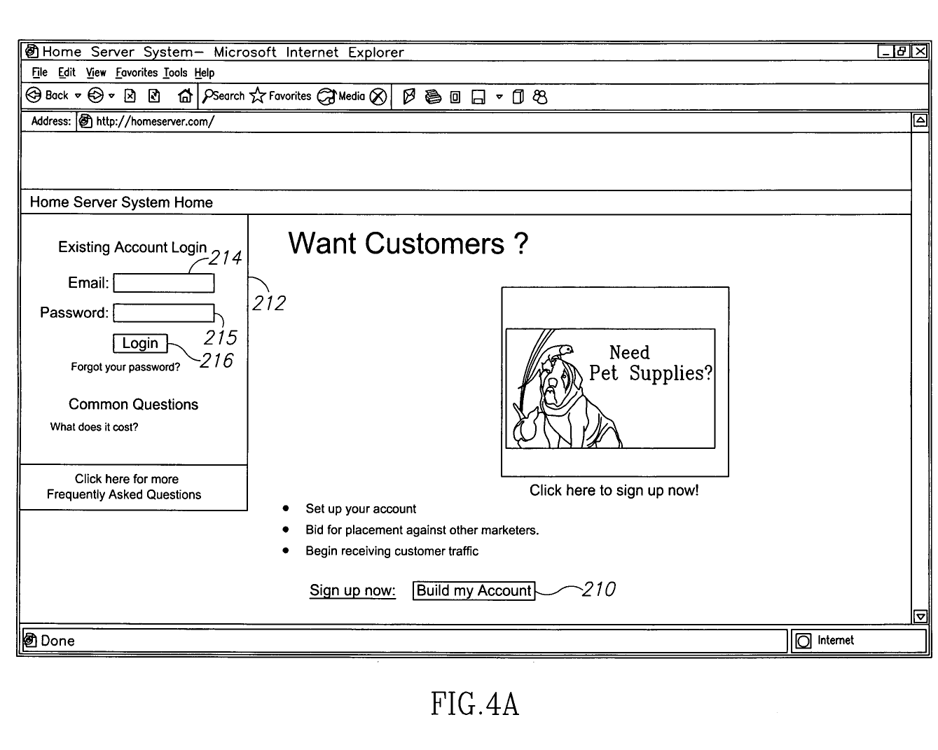

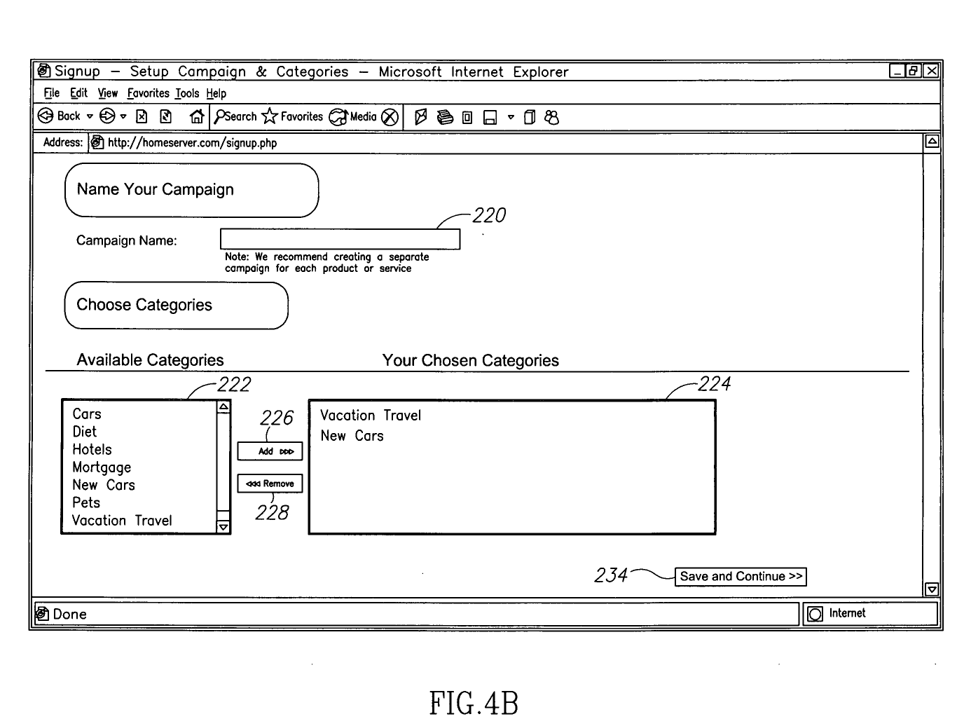

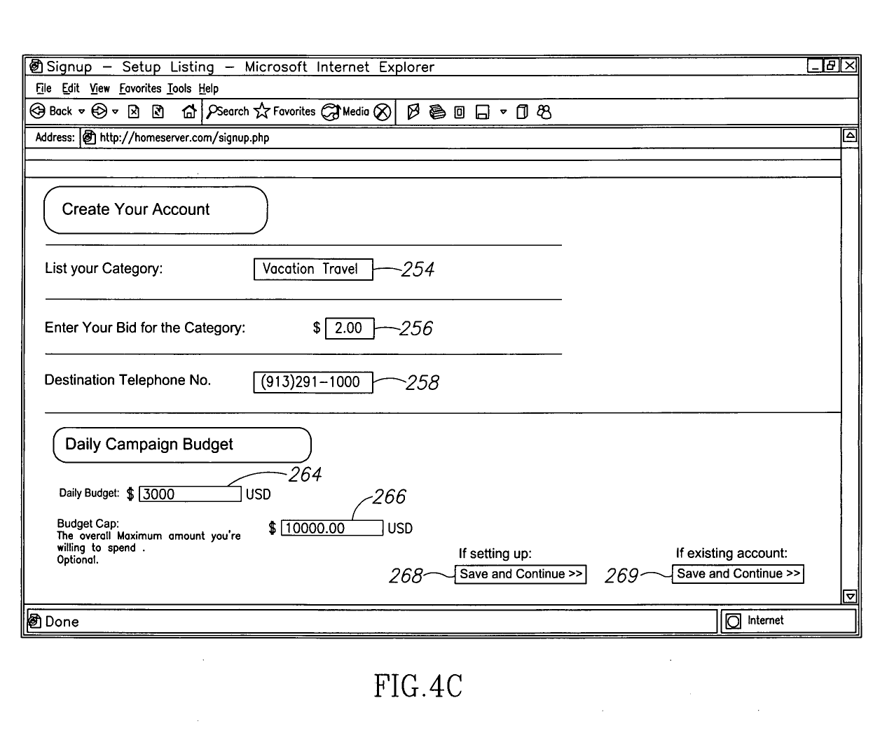

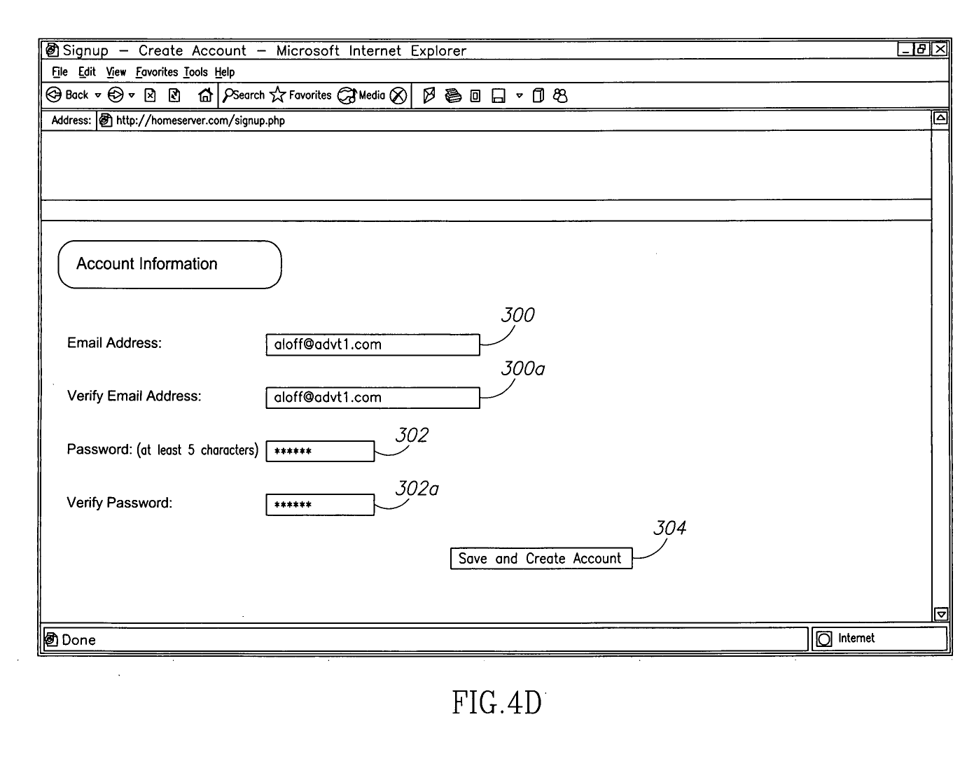

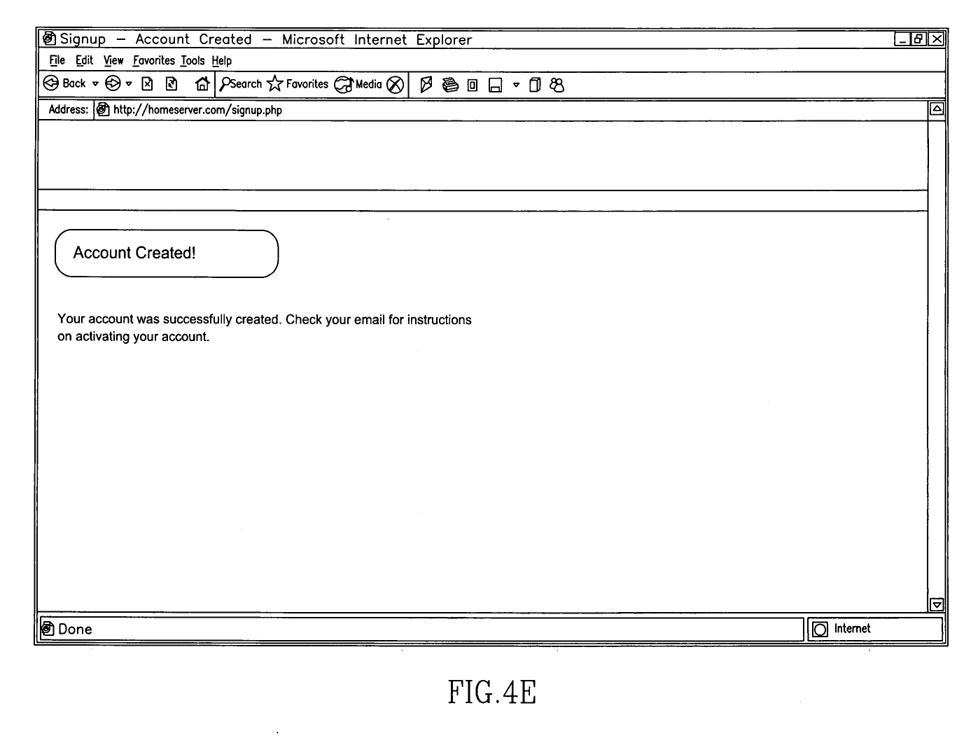

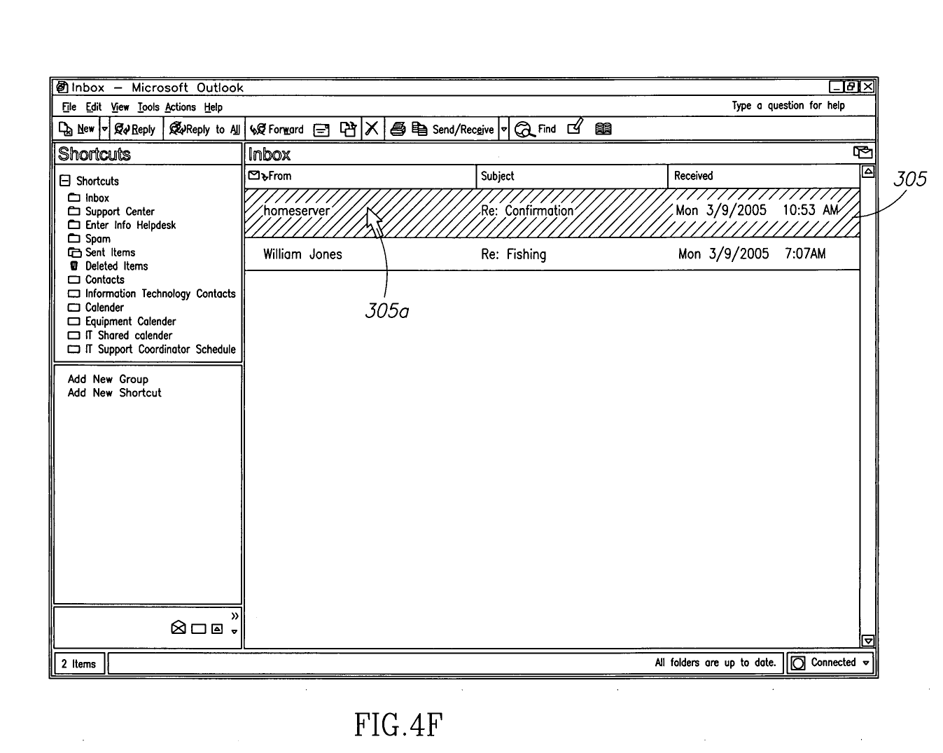

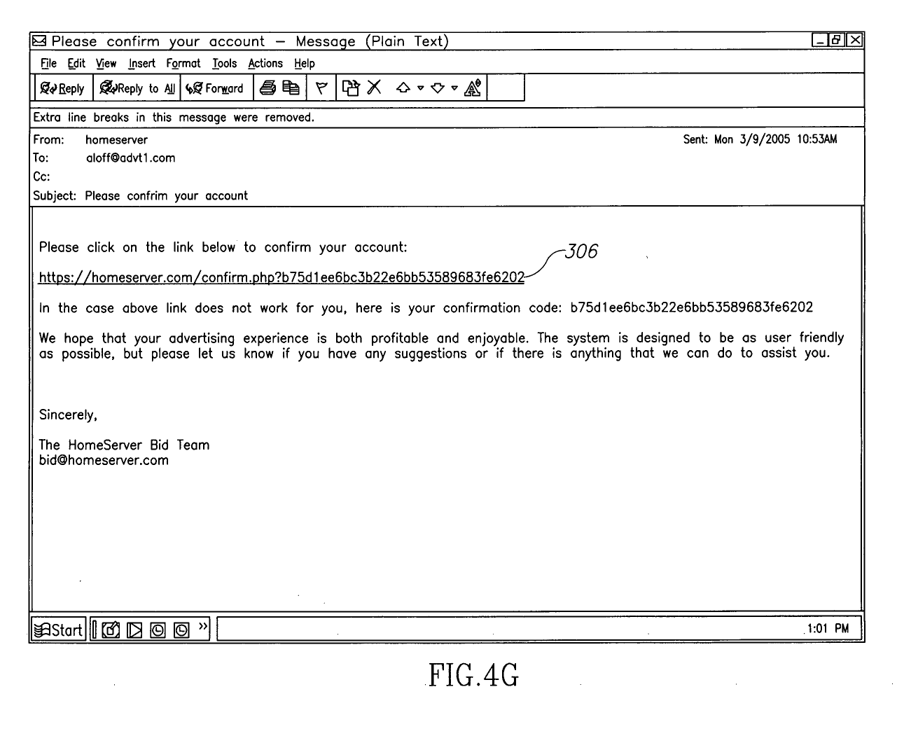

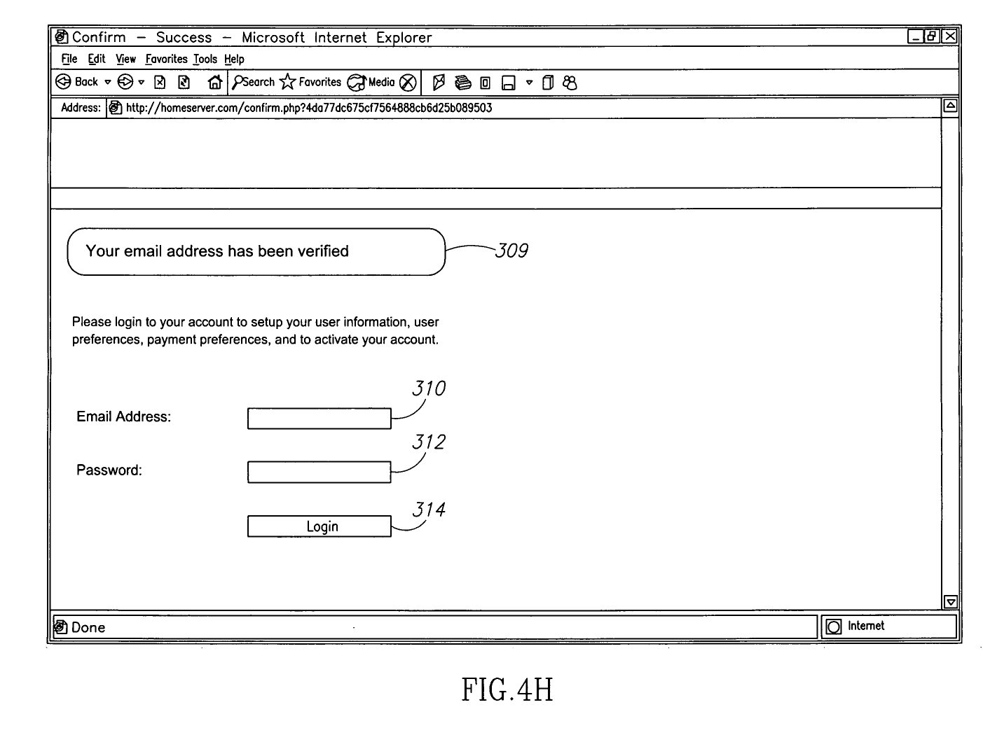

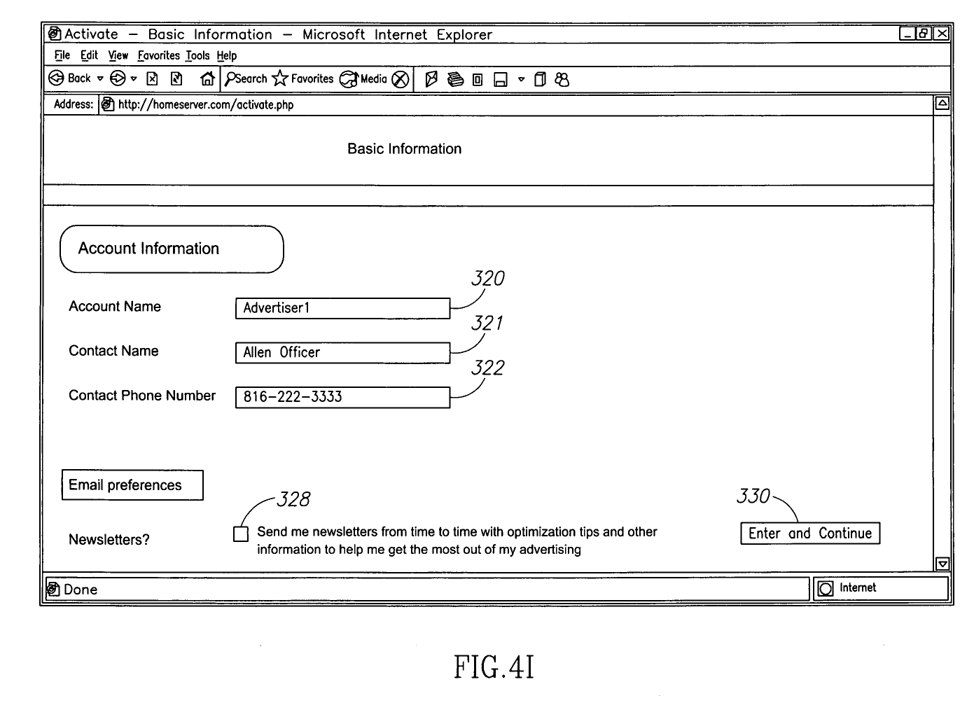

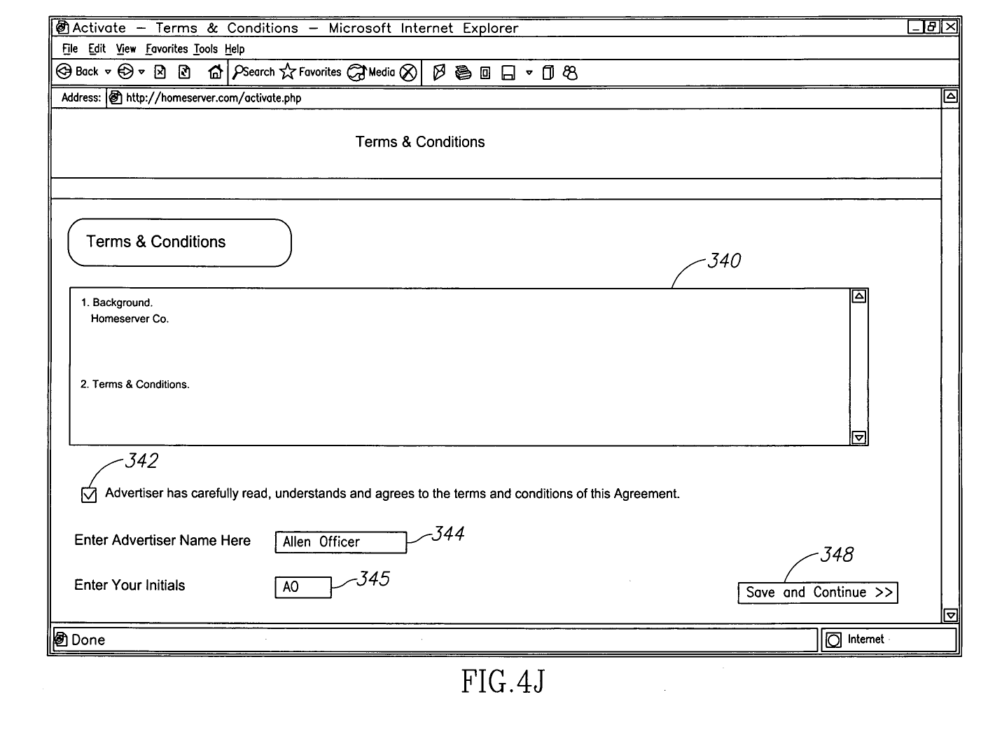

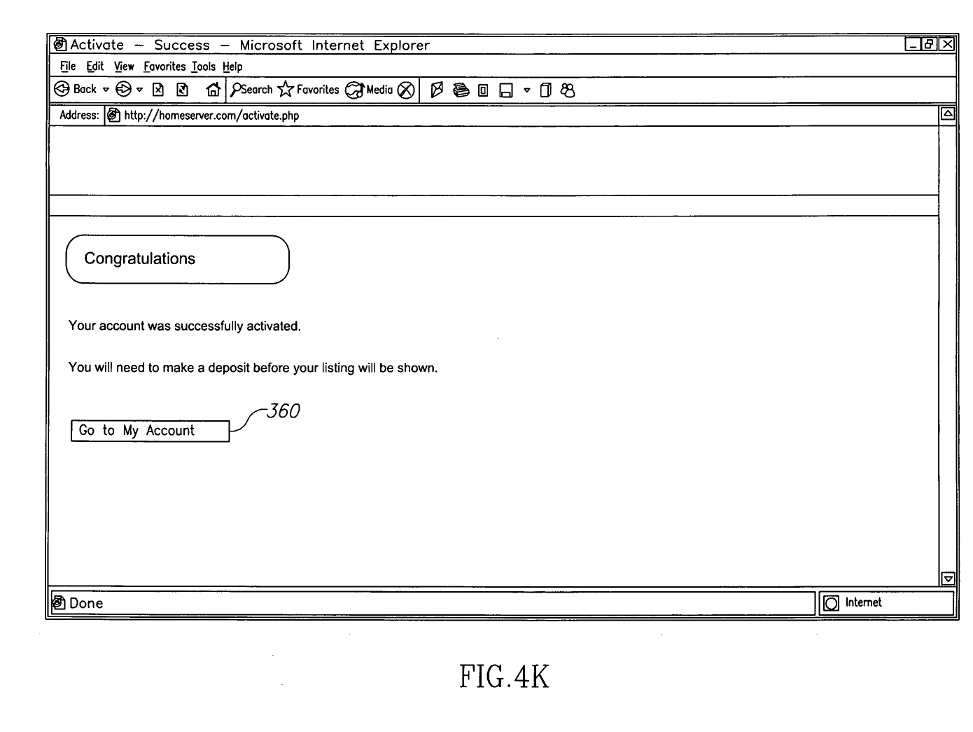

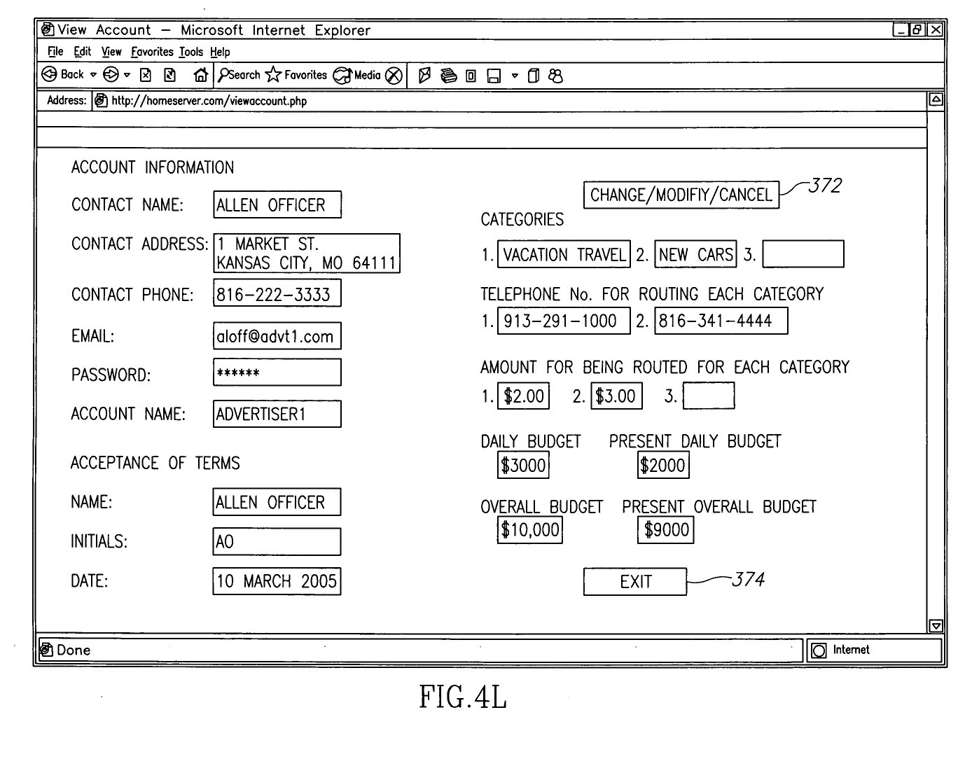

The aforementioned data file 71a, for example, is accessible through the user interface 62, and may be viewed, for example, as shown in the screen shot of FIG. 4L. Once accessed, this file 71a may be changed or modified, by the advertising user entering the modified (new) data into the requisite position on the screen.

The system 50 is such that the processor 58 and rules and policies processor 60, as well as all of the database 70 (and sub-databases 71-78), bidding engine 54, user interface 62 and router 66, are programmable through a system administrator module 80. This module 80 may be internal or external to the system 50 (the home server (HS) 20) and is electronically linked to the processor 58 and rules and policies processor 60. The module 80 is typically operated by a system administrator or the like.

The aforementioned components of the system 50, are arranged, for example, such that individual components may be programmed through the module 80, typically by a system administrator. For example, the module 80 may be used to credit funds to accounts represented by files 71a-71n, and make such funds available to these accounts once these funds become active. Also, for example, the system administrator can add or delete categories, and change incoming telephone numbers associated with categories, in the respective sub-databases 72, 73.

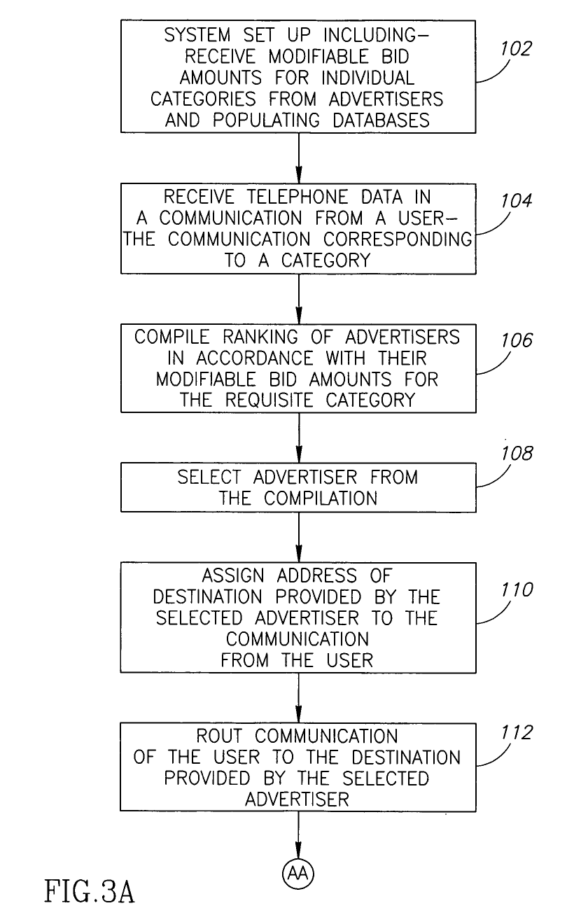

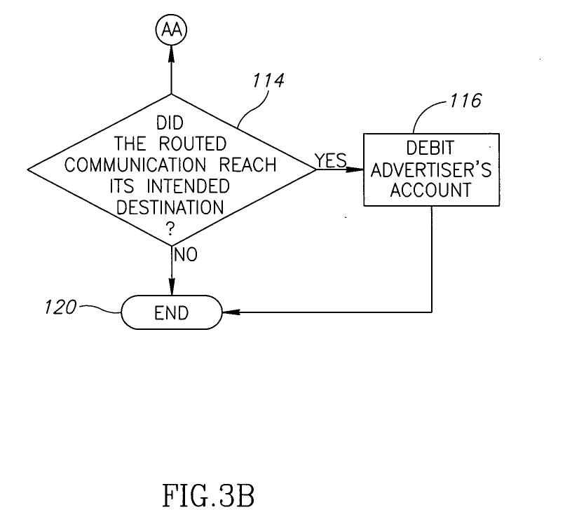

Attention is now directed to FIGS. 3A and 3B, a flow diagram detailing the system in an exemplary operation. Initially, the system is set up at block 102, as each advertiser establishes their accounts, and the system is programmed.

In setting up these accounts, each advertiser, for example, represented by Advertiser #1 to Advertiser #3 (represented by respective servers 30a-30c), selects the desired categories for which they want traffic, typically telephone traffic, by placing a bid (entering a bid amount) for each category. Each advertiser also provides a destination address, for example, a telephone number for the incoming audio (voice) voice call to be routed, that corresponds to the bid (bid amount). An exemplary account set up procedure for advertisers is detailed below and shown in the screen displays of FIGS. 4A-4L.

From the system side, the categories are programmed into the system, and mapped to addresses through the module 80. These addresses are typically telephone numbers that will be accessed or dialed by users, typically via audio or voice calls, interested in the various categories.

Accordingly, when an audio or voice call is received in the system 50, for example, at the home server (HS) 20, from a audio call with the requisite incoming telephone number, the bidding engine 54 is activated for the corresponding category. The bidding engine 54 ranks and selects (or orders) advertisers for the requisite category, based on their bid for that category (provided during set-up), and facilitates the transfer of the communication (the audio or voice call), to the selected advertiser's destination address (for example, as an audio or voice call), in accordance with the selected advertiser's telephone number (provided during account set-up, detailed herein).

A voice call, in the form of data, typically packetized data, is received in the home server (HS) 20, at block 104. The voice call corresponds to a category (stored in sub-database 72), that is linked (mapped) to a preassigned incoming telephone number (stored in sub-database 73). The preassigned telephone number was dialed by the user 34 (by his telephone 36) to access the home server (HS) 20.

With a category selected, the bidding engine 54 is activated. The bidding engine compiles a ranking of advertisers, or orders the advertisers, for example, by criteria, such as in accordance with their present bids, for the requisite category, at block 106. For example, the criteria, is typically in accordance with the monetary amounts of each advertiser's bid amount for the requisite category (from highest monetary value to lowest monetary value). The activation of the bidding engine 54 and compiling or ordering of advertisers based on their bids (modifiable bid amounts) for the requisite category is typically in real time.

The bidding engine 54 then typically selects an advertiser from the compiled ranking (compilation) at block 108. This selection is also typically performed in real time, once the data corresponding to the voice call is received in the home server (HS) 20. The bidding engine 54 typically selects the advertiser in accordance with predetermined criteria, typically, the highest bid (in terms of monetary amount), that is typically a default setting of the rules and policies processor 60 (or preprogrammed into the system through the module 80). Alternately any of the ranked (ordered) advertisers, including if ranked by bid (monetary) amounts, may be selected in accordance with rules and/or policies programmed into the system 50, as applied by the rules and policies processor 60. For example, the bidding engine 54 may select the requisite advertiser based on one or more factors, such as advertiser creditworthiness, daily budget, overall budget, or other criteria.

The bidding engine 54 then assigns the communication, typically the audio call (packetized data corresponding thereto) to a destination addresses. The destination address is, for example, a telephone number, corresponding to the advertiser, whose bid was selected, at block 112.

At block 112, this packetized data is sent to the router 66, that routs the packetized data to a gateway (GW), typically in the voice network 22 or along the Internet 24. The audio or voice call is then sent to the intended destination (typically by a router (R) in the voice network 22 or the router (R) in the Internet 24), corresponding to the telephone number provided by the requisite advertiser for the targeted telephone destination intended destination as designated (provided or inputted) by the advertiser.

It is then determined if the voice call reached its intended destination, at block 114. If the voice call reached the intended destination, the processor 58 records the connection in the sub-database 74, and debits or deducts from the advertiser's account accordingly, in the respective sub-database of database 71, at block 116. The requisite account is debited or deducted from, for example, for the amount of the advertiser's bid for the requisite category. The process moves to block 120, where it ends, until the next call data arrives at the home server (HS) 20.

Similarly, returning to block 114, if the voice call never reached the intended destination, the process moves to block 120, where it ends. The requisite advertiser's account is not debited, as the call is considered by the system 50 to have been unsuccessful. This event is also recorded in the sub-database 74.

While the communication above was illustrated as an audio or vice call, other communications for the call are also permissible, along any of the segments from the call being initially made by the user 34, to reaching its destination. These calls or segments thereof may be wireline, wireless, voice over Internet protocol (VoIP), and the like.

Returning to the account set up by an advertiser or advertising user, as per block 102, the advertiser or advertising user initially directs their web browser or browsing application, for example, Internet Explorer® from Microsoft of Redmond Wash., Netscape Navigator®, or the like, to the uniform resource locator URL for the home server (HS) 20, which is, here, for example, www.homeserver.com. Access to the screen displays is provided, typically through the user interface 62. The templates for these screen displays are, for example, stored in sub-databases 75, 76, and login information, passwords, user names, for access to certain of the aforementioned screen displays is stored in sub-database 77. Once the web site for www.homeserver.com is accessed, the screen display of FIG. 4A is visible to the user.

In FIG. 4A, the screen display is a web page of the web site for setting up an account or accessing an existing account. There is a clickable button 210, that overlies a link to another web page (illustrated by the screen display of FIG. 4B), should the user need or desire to set up an existing account. In this document, a reference to “clicks,” “clicking” and variations thereof, cause the activation of a mouse or other pointing device at a location of the screen display, that typically activates an (underlying) activatable link or the like. There is also a section 212, where an advertiser or advertising user, who has an account with the system, can access their account. Input as to the advertising user's e-mail, box 214, and password, box 215, may be entered, and coupled with the user “clicking” on a login box 216, (and the user name and password matching corresponding data in the sub-database 77), will allow the advertising user to access and manage their account, as they will be directed to the screen display of FIG. 4L (detailed below).

Moving to FIG. 4B, when the user is prompted to name their desired campaign or internal reference and select their desired categories. In the screen display of FIG. 4, there is a section to “NAME YOUR CAMPAIGN”, and a box 220, for receiving input from the advertising user, for the campaign name or internal reference. There is also a section to “CHOOSE CATEGORIES”, with a box 222 (“AVAILABLE CATEGORIES”) listing available categories and preceding or subsequent categories, after a category has been selected. There is also a box 224 (“YOUR CHOSEN CATEGORIES”) where the user selected categories, are listed. For example, the advertiser or advertiser user has selected the categories “Vacation Travel” and “New Cars” in that order.

There are also boxes that cover links for adding categories (box 226) and removing categories (box 228). If the category selection is finished, the user may click on a box 234, where the categories are saved and the process continues.

Creation of the account results in the screen display of FIG. 4C appearing on the monitor of the advertising user. The account is created, as the user enters data, including: 1) a selected category into box 254, 2) a bid amount for the category into box 256; and, 3) a destination address, for example, a telephone number where audio calls are to be directed, into block 258. The advertising user's daily budget is entered into a box 264 and an overall budget cap is entered into box 266. The advertising user may save this entered data by clicking on box 268. The process moves to the screen display of FIG. 4D. Alternately, if an advertising user with an existing account is using this screen display to modify its account, they click on box 269 to return them to the screen display of FIG. 4L.

Referring further to FIG. 4C, the advertising user is prompted to select parameters. In particular, the advertising user enters maximum amounts (these amounts also referred to as bids) that they will pay for each directed communication or call (also known as pay per call) to their targeted destination. These amounts are entered into the bidding engine 54. The bidding engine administers selection of the requisite advertiser, including ordering and ranking of advertisers for each category, typically selected or designated by the system 50 in accordance with rules and/or policies 60, (as detailed below). The bidding engine 54 also facilitates assignment of the communication and routing it typically as an audio call, to a destination, associated with the selected advertiser.

In the screen display of FIG. 4D, the advertising user is prompted to enter the details of their account, for the campaign or internal reference that was created, and input data for these details into the system 50. For example, these functions are performed on the screen display, where the advertising user is prompted to enter his e-mail and chose a corresponding password, in boxes 300 and 302, and verify this inputted data, in boxes 300a and 302a (that is also entered into the sub-database 77). There is also a box 304, that if clicked on by the user, will cause the system 50 to save the account and create the account, corresponding to the entered e-mail address and password, and move to the screen display of FIG. 4E.

All information entered into the account, as input into the screen displays of FIGS. 4B-4D, is imported into the corresponding accounts database 71, and is assigned a sub database, under the accounts database 71. The inputted data for this individual count, as created, is entered into and shown for example, in the screen display of FIG. 4L, and detailed below.

The now-created account for the advertising user's campaign is acknowledged. This acknowledgement is shown by the screen display of FIG. 4E.

The system 50 (from the home server (HS) 20) then typically sends an e-mail, to the advertising user. This communication may be another electronic communication as well as postal or the like. This e-mail requests account confirmation by the advertising user, and until such confirmation is received, the system 50 suspends the account. For example, as shown in FIG. 4F, the e-mail is received in the in-box of the advertising user, as a text line 305. The adverting user opens the e-mail, by clicking (shown by the arrow 305a) on the text line 305, and the e-mail of the screen display of FIG. 4G appears on the advertising user's computer. The body of this non-opened e-mail includes a link 306, that once clicked, will be sent to the system 50 of the home server (HS) 20, serving as an acknowledgement from the advertising user that the e-mail has been received.

With the acknowledgement received, the system 50 also sends the advertising user a confirmation of their e-mail address and prompts the user to enter data for reentry into the system 50, through the user interface 62. The system 50 sends the advertising user a communication with the screen display of FIG. 4H indicating the advertising user's e-mail address has been verified (box 309), with the prompts therein satisfied, as the advertising user enters their e-mail address in box 310, and the password for this requisite campaign in box 312. The advertising user then clicks the login box 314, to input the e-mail address and password into the system 50. This inputted data is received, and, if authorized, the advertising user is permitted entry (reentry) into the system 50 by receiving the screen display shown in FIG. 4I.

For example, in the screen display of FIG. 4I, as received by the advertising user, there are boxes for the account name 320, contact name 321 and contact phone number 322 of the entity that controls the account. There is also a check box 328 for e-mail preferences, and a box 330 to enter this input and move to the next screen display of FIG. 4J.

With the account (campaign) information entered, the advertising user is presented with terms and conditions for using the system, as per the screen display of FIG. 4J. The advertising user is prompted to accept these terms and conditions, and input from the advertising user must be received by the system, typically at the home server (HS) 20, that the terms and conditions are accepted, prior to the advertising user's account being activated.

For example, as shown in the screen display of FIG. 4J, terms and conditions for creating and maintaining an account on the system are listed in a box 340. There is also a check box 342 to indicate acknowledgement and acceptance of the terms, as well as boxes for the advertising user to input their name 344 and initials 345. A box 348, that when clicked on to continues the process, is also part of the screen display.

With the terms and conditions accepted, the advertising user's account is activated, such that the advertising user is permitted to enter the system. Acknowledgement of the activation is shown, for example, in the screen display of FIG. 4K. The user may now access their account, by clicking on the box 360 for account access.

With the campaign and account associated therewith now created, and typically stored in the system, it is typically reviewed by the system administrators. Once the review is complete, the campaign is taken off suspension and activated in the system 50. The advertising user now has full access to their account and can view it, as per the exemplary screen display of FIG. 4L. This now “live” account is operational to the bidding engine 54.

For example, account information of the contact name, contact address, contact phone and contact e-mail may be changed by accessing the display screen of FIG. 4L and modifying the information in the corresponding boxes. All other information plus the information under “Acceptance of Terms” is typically only changeable by contacting the system administrator. Should one or more categories be desired to be changed, either with or without changing the destination telephone number or bid, button 372 is clicked. This click sends the advertising user to the server displays of FIGS. 4B and 4C, that operate as detailed above. In all cases, when exiting the system is desired, exit button 374 is clicked, and the advertising user exits the system.

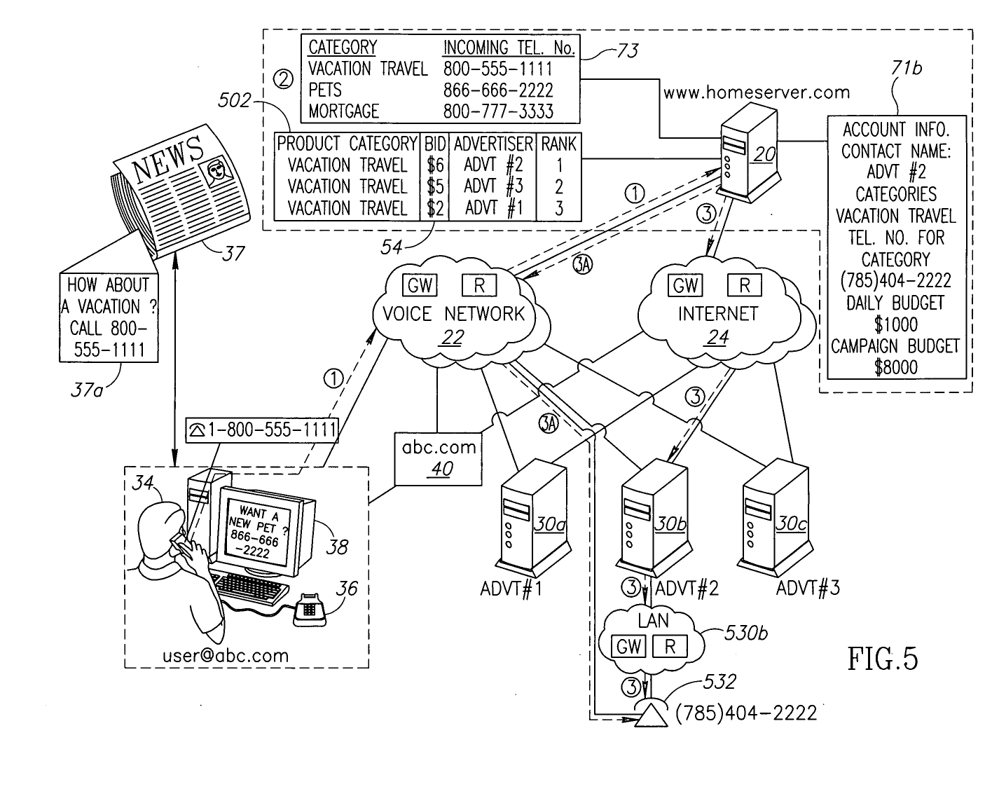

FIG. 5 shows the system 50 (FIG. 2A) of the home server (HS) 20 in an exemplary operation, based on the diagram of FIG. 1. Initially, a user 34, has obtained a telephone number from one of various media, such as print media (newspapers, magazines, flyers, leaflets, etc.), broadcast media, television, radio, etc, or electronic media, web pages, text messages, etc. For example, the telephone number (i.e., 1-800-555-1111) obtained by the user 34 is from a page 37a of a newspaper 37, and is for a vacation. In the requisite database 73, this telephone number is mapped to the category “Vacation Travel.”

The user 34 dials the telephone number 1-800-555-1111 (through his telephone 36), as indicated by broken line arrow and circled “1”. An audio (voice) call is communicated to the home server (HS) 20, for example, through the voice network 22. In the voice network 22, the audio call is typically converted into packets, for use by the home server (HS) 20.

Once the packets associated with the audio call are received at the home server (HS) 20 or components associated therewith, collectively, the home server (HS) 20, as indicated by the circled “2”, the bidding engine 54 activates. The bidding engine 54 typically operates in real time.

The bidding engine 54 obtains the category from the correspondingly mapped telephone number, and compiles (orders) a list of the advertisers, who have bided on that category. The list or compilation is typically produced in a ranked order, for example, from highest bid amount for the category, to the lowest bid amount for the category, as shown by the listing 502. A bid is selected, in accordance with rules and policies, and typically is the highest bid (in terms of monetary amount), for example, the bid of $6 from Advertiser (Advt #2), who has been ranked first, for the requisite category, here, for example, “Vacation Travel.”

The bidding engine 54 sends this data to the processor 58, that finds the file, for example, file 71b from the account sub-database 71, for the account of Advertiser #2 (Advt. #2). An abridged version of an exemplary file 71b is shown in FIG. 5. From this file 71b of Advertiser #2, the telephone number for the destination designated by Advertiser #2 is obtained, for example (785) 404-2222. The processor 58 signals the router 66 to send the audio call (in packets) typically, to the Internet 24, for routing to the destination for the telephone number (785) 404-2222. For example, the destination for the telephone number (785) 404-2222 is reached via the server 30b through a local area network (LAN) 530b, to a telephone 532 (the packets being converted to tones via a gateway (G) in the LAN 530b).

The pathway over which the redirected audio call travels is indicated by the broken line arrow and the circled “3”. The user's audio call is connected to the telephone 532 associated with Advertiser #2, the selected bidder for the category, “Vacation Travel.” Once the audio call is received at the destination, for example, telephone 532, the audio call is considered to be successful. Accordingly, the daily budget would be debited by the bid amount $6, as would the overall budget.

Alternately, the redirected audio call may be sent to the voice network, and then to the destination telephone number, represented by the telephone 532 of Advertiser #2. This pathway is represented by the broken line arrows and the circled “3A”. Once the packetized communication is received in the voice network 22, it has been converted to a telephonic transmission, suitable for receipt by the telephone 532 at the selected destination of Advertiser #2. Once the audio call is received at the destination, for example, telephone 532, the audio call is considered to be successful. Accordingly, the daily budget would be debited by the bid amount $6, as would the overall budget.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments have been described, so as to enable one of skill in the art to practice the disclosed subject matter, the preceding description is intended to be exemplary only. It should not be used to limit the scope of the disclosed subject matter, which should be determined by reference to the following claims.

What is claimed is:

1. A method for providing a communication to a recipient, comprising:
maintaining a database including, a plurality of addresses, each address associated with each recipient who has entered a modifiable bid amount for at least one category, and, at least one modifiable bid amount corresponding to the at least one category;
receiving a communication from a user;
associating the communication with the at least one category; and
assigning the communication to the address associated with at least one recipient who has entered a modifiable bid amount.

2. The method of claim 1, wherein at least one modifiable bid amount corresponding to the at least one category includes a plurality of modifiable bid amounts, and assigning the communication includes ordering the modifiable bid amounts for the at least one category in accordance with their amounts and assigning the communication to the address associated with the at least one recipient who has entered the highest modifiable bid amount at the time the communication is received.

3. The method of claim 2, wherein assigning the communication includes transferring the communication to the address associated with the at least one recipient.

4. The method of claim 3, wherein the address associated with the at least one recipient includes a telephone number.

5. The method of claim 3, wherein the communication includes packets.

6. The method of claim 1, wherein the communication received from the user includes telephone data.

7. The method of claim 1, additionally comprising: deducting an amount of money corresponding to the modifiable bid amount, from an account associated with the at least one recipient, once the communication assigned to the address of the at least one recipient has reached the destination corresponding to the address associated with the at least one recipient.

8. A system for providing a communication to a recipient, comprising:
at least one database including, a plurality of addresses, each address associated with each recipient who has entered a modifiable bid amount for at least one category, and, at least one modifiable bid amount corresponding to the at least one category;
a first component configured for receiving a communication from a user;
a second component configured for associating the communication with the at least one category; and,
a third component configured for assigning the communication to the address associated with at least one recipient who has entered a modifiable bid amount.

9. The system of claim 8, wherein the third component configured for assigning the communication is additionally configured for transferring the communication to the address associated with the at least one recipient.

10. The system of claim 8, wherein the first and third components are configured for handling telephone data.

11. The system of claim 10, wherein components configured for handling telephone data are configured for handling packets.

12. The system of clam 8, additionally comprising: a fourth component for deducting an amount of money corresponding to the modifiable bid amount, from an account associated with the at least one recipient, once the communication assigned to the address of the at least one recipient has reached the destination corresponding to the address associated with the at least one recipient.

13. The system of claim 12, wherein the first component, the second component and the third component define a bidding engine.

14. The system of claim 13, additionally comprising a server, the server including the at least one database, the bidding engine, and the fourth component.

15. A computer-usable storage medium having a computer program embodied thereon, for causing a suitably programmed system to provide a communication to a recipient, by performing the following steps, when such program is executed on the system, the steps comprising:
maintaining a database including, a plurality of addresses, each address associated with each recipient who has entered a modifiable bid amount for at least one category, and, at least one modifiable bid amount corresponding to the at least one category;
receiving a communication from a user;
associating the communication with the at least one category; and,
assigning the communication to the address associated with at least one recipient who has entered a modifiable bid amount.

16. The computer usable storage medium of claim 15, wherein at least one modifiable bid amount corresponding to the at least one category includes a plurality of modifiable bid amounts, and the step of assigning the communication includes ordering the modifiable bid amounts for the at least one category in accordance with their amounts and assigning the communication to the address associated with the at least one recipient who has entered the highest modifiable bid amount at the time the communication is received.

17. The computer usable storage medium of claim 16, wherein the step of assigning the communication includes transferring the communication to the address associated with the at least one recipient.

18. The computer usable storage medium of claim 17, wherein the address associated with the at least one recipient includes a telephone number.

19. The computer usable storage medium of claim 15, wherein the communication received from the user includes telephone data.

20. The computer usable storage medium of claim 15, additionally comprising the step of:
deducting an amount of money corresponding to the modifiable bid amount, from an account associated with the at least one recipient, once the communication assigned to the address of the at least one recipient has reached the destination corresponding to the address associated with the at least one recipient.

21. A method for providing a communication to a recipient, comprising:
maintaining a database including, a plurality of addresses, each address associated with each recipient of a plurality of recipients who have entered a modifiable bid amount for at least one category, and, the modifiable bid amounts corresponding to the at least one category;
receiving a communication from a user;
ordering the modifiable bid amounts for the at least one category in accordance with at least one first predetermined criteria;
associating the communication with the at least one category; and,
assigning the communication to the address associated with at least one recipient whose modifiable bid amount for the at least one category is selected in accordance with at least one second predetermined criteria.

22. The method of claim 21, wherein the at least one first criteria is monetary amount.

23. The method of claim 22, wherein the at least one second criteria is the highest monetary amount.

24. The method of claim 21, wherein the at least one second criteria is in accordance with at least one rule or at least one policy.

25. The method of claim 21, wherein assigning the communication includes transferring the communication to the address associated with the at least one recipient.

26. The method of claim 25, wherein the address associated with the at least one recipient includes a telephone number.

27. The method of claim 21, wherein the communication includes packets.

28. The method of claim 21, wherein the communication received from the user includes telephone data.

29. The method of claim 21, additionally comprising: deducting an amount of money corresponding to the modifiable bid amount, from an account associated with the at least one recipient, whose modifiable bid amount for the at least one category was selected in accordance with at least one second predetermined criteria.

30. A system for providing a communication to a recipient, comprising:
at least one database including, a plurality of addresses, each address associated with each recipient of a plurality of recipients who have entered a modifiable bid amount for at least one category, and, the modifiable bid amounts corresponding to the at least one category;
a first component for receiving a communication from a user; and,
a bidding engine configured for:
ordering the modifiable bid amounts for the at least one category in accordance with at least one first predetermined criteria;
associating the communication with the at least one category; and,
assigning the communication to the address associated with at least one recipient whose modifiable bid amount for the at least one category is selected in accordance with at least one second predetermined criteria.

31. The system of claim 30, additionally comprising: at least one first module configured for programming the at least one first predetermined criteria into the bidding engine.

32. The system of claim 31, wherein the at least one first module is additionally configured for programming the at least one second criteria into the bidding engine.

33. The system of claim 31, additionally comprising: at least one second module for processing at least one rule or at least one policy so as to define the at least one second predetermined criteria.

34. The system of claim 30, wherein the bidding engine, configured for assigning the communication, is additionally configured for transferring the communication to the address associated with the at least one recipient whose modifiable bid amount for the at least one category was selected.

35. The system of claim 30, wherein the bidding engine is configured for handling telephone data.

36. The system of claim 35, wherein the bidding engine configured for handling telephone data is configured for handling packets.

37. The system of claim 30, additionally comprising: a fourth component configured for deducting an amount of money corresponding to the modifiable bid amount, from an account associated with the at least one recipient, whose modifiable bid amount for the at least one category was selected in accordance with at least one second predetermined criteria.

38. The system of claim 30, additionally comprising a server, the server including the at least one database, the first component, the second component, and the bidding engine.

39. A computer-usable storage medium having a computer program embodied thereon, for causing a suitably programmed system to provide a communication to a recipient, by performing the following steps, when such program is executed on the system, the steps comprising:
maintaining a database including, a plurality of addresses, each address associated with each recipient of a plurality of recipients who have entered a modifiable bid amount for at least one category, and, the modifiable bid amounts corresponding to the at least one category;
receiving a communication from a user;
ordering the modifiable bid amounts for the at least one category in accordance with at least one first predetermined criteria;
associating the communication with the at least one category; and,
assigning the communication to the address associated with at least one recipient whose modifiable bid amount for the at least one category is selected in accordance with at least one second predetermined criteria.

40. The computer-usable storage medium of claim 39, wherein the at least one first predetermined criteria is monetary amount.

41. The computer-usable storage medium of claim 40, wherein the at least one second predetermined criteria is the highest monetary amount.

42. The computer-usable storage medium of claim 40, wherein the at least one second predetermined criteria is in accordance with at least one rule or at least one policy.

43. The computer-usable storage medium of claim 39, wherein assigning the communication includes transferring the communication to the address associated with the at least one recipient.

44. The computer-usable storage medium of claim 39, wherein the address associated with the at least one recipient includes a telephone number.

45. The computer usable storage medium of claim 39, wherein the communication received from the user includes telephone data.

46. The computer usable storage medium of claim 39, additionally comprising the step of:
deducting an amount of money corresponding to the modifiable bid amount, from an account associated with the at least one recipient, once the communication assigned to the address of the at least one recipient has reached the destination corresponding to the address associated with the at least one recipient.

47. A method for providing a communication to a recipient, comprising:
maintaining a database including, a plurality of addresses, each address associated with each recipient of a plurality of recipients who have entered a modifiable bid amount for at least one category, and, the modifiable bid amounts corresponding to the at least one category;
receiving a communication from a user;
ordering the modifiable bid amounts for the at least one category in accordance with their amounts;
associating the communication with the at least one category; and,
assigning the communication to the address associated with the recipient whose modifiable bid amount for the at least one category is the highest ordered bid.

48. The method of claim 47, wherein assigning the communication includes transferring the communication to the address associated with the at least one recipient.

49. The method of claim 47, wherein the address associated with the at least one recipient includes a telephone number.

50. The method of claim 47, wherein the communication includes packets.

51. The method of claim 47, wherein the communication received from the user includes telephone data.

52. The method of claim 47 additionally comprising:
deducting an amount of money corresponding to the modifiable bid amount, from an account associated with the recipient, whose modifiable bid was the highest bid amount, once the communication assigned to the address of the recipient has reached the destination corresponding to the address associated with the recipient.

53. A method for providing a communication to a recipient, comprising:
receiving modifiable bid amounts from recipients, each modifiable bid amount associated with at least one category and an address corresponding to the recipient associated with the respective modifiable bid amount;
receiving a communication from a user;
ordering the modifiable bid amounts for the at least one category in accordance with at least one first predetermined criteria;
associating the communication with the at least one category;
selecting the modifiable bid amount based on at least one second predetermined criteria; and,
assigning the communication to the address associated with the recipient whose modifiable bid amount for the at least one category was selected.

54. The method of claim 53, wherein the at least one first criteria is monetary amount.

55. The method of claim 54, wherein the at least one second criteria is the highest monetary amount.

56. The method of claim 54, wherein the at least one second criteria is in accordance with at least one rule or at least one policy.

57. The method of claim 53, wherein assigning the communication includes transferring the communication to the address associated with the at least one recipient.

58. The method of claim 53, wherein the address associated with the at least one recipient includes a telephone number.

59. The method of claim 53, wherein the communication includes packets.

60. The method of claim 53, wherein the communication received from the user includes telephone data.

61. The method of claim 53 additionally comprising:
deducting an amount of money corresponding to the modifiable bid amount, from an account associated with the recipient, whose modifiable bid was selected, once the communication assigned to the address of the recipient has reached the destination corresponding to the address associated with the recipient.

62. A system for providing a communication to a recipient, comprising:
a first component for receiving modifiable bid amounts from recipients, each modifiable bid amount associated with at least one category and an address corresponding to the recipient associated with the respective modifiable bid amount;
a second component for receiving a communication from a user; and,
a bidding engine configured for:
ordering the modifiable bid amounts for the at least one category in accordance with at least one first predetermined criteria;
associating the communication with the at least one category;
selecting the modifiable bid amount based on at least one second predetermined criteria; and,
assigning the communication to the address associated with the recipient whose modifiable bid amount for the at least one category was selected.

63. The system of claim 63, additionally comprising: at least one first module configured for programming the at least one first predetermined criteria into the bidding engine.

64. The system of claim 63, wherein the at least one first module is additionally configured for programming the at least one second criteria into the bidding engine.

65. The system of claim 63, additionally comprising: at least one second module for processing at least one rule or at least one policy so as to define the at least one second predetermined criteria.

66. The system of claim 62, wherein the bidding engine, configured for assigning the communication, is additionally configured for transferring the communication to the address associated with the at least one recipient whose modifiable bid amount for the at least one category was selected.

67. The system of claim 62, wherein the bidding engine is configured for handling telephone data.

68. The system of claim 67, wherein the bidding engine configured for handling telephone data is configured for handling packets.

69. The system of claim 69, additionally comprising: a third component configured for deducting an amount of money corresponding to the modifiable bid amount, from an account associated with the at least one recipient, whose modifiable bid amount for the at least one category was selected in accordance with at least one second predetermined criteria.

70. The system of claim 69, additionally comprising a server, the server including the first component, the second component, the third component and the bidding engine.

71. A computer-usable storage medium having a computer program embodied thereon, for causing a suitably programmed system to provide a communication to a recipient, by performing the following steps, when such program is executed on the system, the steps comprising:
receiving modifiable bid amounts from recipients, each modifiable bid amount associated with at least one category and an address corresponding to the recipient associated with the respective modifiable bid amount;
receiving a communication from a user;
ordering the modifiable bid amounts for the at least one category in accordance with at least one first predetermined criteria;
associating the communication with the at least one category;
selecting the modifiable bid amount based on at least one second predetermined criteria; and,
assigning the communication to the address associated with the recipient whose modifiable bid amount for the at least one category was selected.

72. The computer-usable storage medium of claim 71, wherein the at least one first predetermined criteria is monetary amount.

73. The computer-usable storage medium of claim 72, wherein the at least one second predetermined criteria is the highest monetary amount.

74. The computer-usable storage medium of claim 72, wherein the at least one second predetermined criteria is in accordance with at least one rule or at least one policy.

75. The computer-usable storage medium of claim 71, wherein assigning the communication includes transferring the communication to the address associated with the at least one recipient.

76. The computer-usable storage medium of claim 71, wherein the address associated with the at least one recipient includes a telephone number.

77. The computer usable storage medium of claim 71, wherein the communication received from the user includes telephone data.

78. The computer usable storage medium of claim 71, additionally comprising the step of:
deducting an amount of money corresponding to the modifiable bid amount, from an account associated with the at least one recipient, once the communication assigned to the address of the at least one recipient has reached the destination corresponding to the address associated with the at least one recipient.
